(19) United States
(12) Patent Application Publication
(10) Pub. No.: US 2005/0020761 A1
(43) Pub. Date: Jan. 27, 2005

(54) Antistatic resin composition

(76) Inventors: Shiro Arai, Fukushima-ken (JP); Katushi Momose, Fukushima-ken (JP); Hiroaki Nakagawa, Yamaguchi-ken (JP); Takashi Kozeki, Yamaguchi-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/491,497

(22) PCT Filed: Oct. 3, 2002
(86) PCT No.: PCT/JP02/10329

(30) Foreign Application Priority Data
Oct. 11, 2001 (JP) 2001-313888
Feb. 8, 2002 (JP) 2002-031884

(51) Int. Cl. C08K 3/00

(52) U.S. Cl. 524/500; 524/502

(57) ABSTRACT

A small account of polyvalent metal compound is added to an antistatic resin composition comprising a hydrophilic thermoplastic polymer. A shaped product of the resin composition retains permanent antistatic property and a beautiful appearance due to not only freeness from attachment of dust, etc., but also suppression of haze or discoloration caused by attachment of a gaseous soiling substance, such as an acidic and a basic gas in the air. The resin composition also provides a shaped container product free from occurrence of attached substance on an electronic part or optical part even when the part is subjected to irradiation with ultraviolet light after storage in the container product.

### TECHNICAL FIELD

The present invention relates to an improvement in antistatic resin composition having permanent antistatic property, particularly an antistatic resin composition showing least attachability of soiling substance and capable of stably providing a shaped product with a beautiful appearance.

### BACKGROUND ART

Ordinary plastic materials are insulating materials and are charged to attract fine particles, and fine particles drifting in the air have been conventionally considered as soiling substances therefor. As a method for obviating the soiling with fine particles, countermeasures for static electricity are generally effective and the following methods have been investigated for imparting an antistatic property to a resin composition or a shaped product thereof.
(1) Internal addition and kneading of an antistatic agent.
(2) Surface coating with an antistatic agent.
(3) Surface coating with a silicon compound.
(4) Reforming of chemical structure of a plastic compound.

Among the above-mentioned methods, the internal addition and kneading of an antistatic agent is not sufficient for permanent static prevention and is accompanied with problems, such that the antistatic effect is lost when the antistatic agent present at the surface is removed by washing with water or by rubbing, excessive bleeding to the surface of the antistatic agent is liable to cause adhesive sticking of refuse or dust, and the transparence is liable to be impaired.

The surface coating with an antistatic agent or a silicone compound is accompanied with a practically serious problem that the antistatic agent is drastically reduced when such an agent or compound is removed by washing or rubbing.

The chemical structure reforming of a plastic compound is a method of introducing a hydrophilic group into such a plastic compound as by polymerization or other methods. However, a substantially large amount of hydrophilic group is generally required to be incorporated in order to exhibit antistatic effect, so that the mechanical properties and other properties are adversely affected by moisture absorption.

As a method for imparting a permanent antistatic effect to a plastic material while obviating the above-mentioned problems, it has been known to use an antistatic resin composition comprising a hydrophilic polymer and an insulating resin. There have been introduced methods of incorporating hydrophilic polymers, such as polyethylene oxide, polyether-ester-amide and quaternary ammonium salt-containing copolymers, into thermoplastic resins, such as polystyrene, ABS and PMMA (“Japan Society of Static Electricity”, Vol. 21, No. 5, pp. 212-219 (1997)). Herein, “permanent antistatic property” is unlike a non-persistent antistatic property which may be obtained by application of an antistatic agent or bleeding-out to the surface of a shaped article of an antistatic agent kneaded into an ordinary thermoplastic resin and can be remarkably reduced by wiping of the surface, but means a permanently and persistently exhibited antistatic property which is developed by an antistatic agent stably held inside a thermoplastic resin constituting a shaped product and is not essentially reduced by wiping of the shaped product.

As a preferred example of such a permanently antistatic resin composition, the present applicant already developed a thermoplastic resin composition having permanent antistatic property and also good transparence, preferably by further incorporating an anionic surfactant into a thermoplastic resin composition comprising a graft copolymer of a rubber trunk polymer having an alkylene oxide group (Japanese Patent Publication (JP-B) 59-2462; corr. to GB-A 2070046).

While the function mechanism of the above-mentioned thermoplastic resin composition exhibiting permanent antistatic property has not been fully clarified as yet, it is considered that a rubber trunk polymer comprising a monomer having an alkylene oxide group and a conjugated diene or an acrylate ester as one component is dispersed, at the time of processing, in the graft component resin or a mixture of the graft component resin and a thermoplastic resin as the matrix component in the form of mutual bridges, and an antistatic agent added thereto is selectively adsorbed principally by the rubber trunk polymer, so that when a charging member contacts the shaped body, electric charges of the opposite polarity are moved principally through the rubber trunk polymer phase adsorbing the antistatic agent to be quickly accumulated at the contact surface, thereby dissipating and neutralizing the charges given by the charging member.

However, several problems have been found with the above-mentioned antistatic resin compositions containing a class of hydrophilic polymers as base polymers, from practical points of view. For example, several of such antistatic resin compositions inclusive of the graft copolymer-type antistatic resin composition developed by the present applicant, are characterized by an ability of providing a shaped product having a good transparence in addition to the antistatic property, but the shaped products were sometimes accompanied with haze or a lowering in transparence due to discoloration attributable to gaseous soiling substances in some cases. Particularly, there has been found a liability that such a shaped product is hazed due to an acid gas or a basic gas at a level of concentration ordinarily present in the air. Further, there has been also encountered a difficulty that an electronic part or an optical part packaged within a container formed of such an antistatic resin composition is liable to be hazed or discolored in some cases.

### DISCLOSURE OF INVENTION

Accordingly, an object of the present invention is to provide an antistatic resin composition providing a shaped product capable of stably retaining a beautiful appearance and permanent antistatic property.

Another object of the present invention is to provide an antistatic resin composition capable of providing a shaped product in the form of a packaging container free from the occurrence of attachments adversely affecting an electronic part or an optical part packaged therein.

According to our study, it has been found possible to achieve the above-mentioned object by imparting a compositional improvement to an antistatic resin composition comprising a hydrophilic polymer as a base polymer.

More specifically, according to the present invention, there is provided an antistatic resin composition, comprising:
(a) a hydrophilic polymer: 3-100 wt. parts,
(b) a thermoplastic resin: 0-97 wt. parts (giving a total of 100 wt. parts together with the hydrophilic polymer (a)), and
(c) a polyvalent metal compound: 0.001-0.5 wt. part.

Some history and details as to how we have arrived at the present invention as a result of study for achieving the above object, will now be briefly described.

The above-mentioned difficulty of haze and discoloration with a gaseous soiling substance of a shaped product with respect to a permanent antistatic resin composition comprising a hydrophilic polymer as a base polymer (as disclosed in “Japan Society of Static Electricity”, vol.21, No.5, pp.212-219 (1997); JP-B 59-2462, etc.) has been found or become problematic along with an increasing demand for a higher level of performance required of an antistatic resin composition. More specifically, an antistatic resin composition for preventing attachment due to an electrostatic charge of minute particles is also used in the field of semiconductor production processes where attachment of particulate substances is particularly problematic, and along with a progress in such semiconductor production processes, the size of problematic fine particles is becoming smaller. Thus, even if a resin composition having good permanent antistatic property comprising a hydrophilic polymer as a base polymer is used, there has been possibly found a problem of haze or discoloration of a shaped product due to minute particulate substances or, in the case of a shaped container product, a problem of haze occurring on the surface of the content material in the container. Moreover, it has become clear that such haze or discoloration is caused by soiling with minute substances formed by adsorption and crystallization of gaseous substances contained in the air rather than the attractive attachment of minute particles drifting in the air. The gaseous substances may include a nonpolar gas, an acidic gas and a basic gas, and it has become clear that the adsorption of an acidic gas and/or a basic gas rather causes minute particles than a nonpolar gas. Particularly, a photomask or a protective film therefor (generally called a pelicle) as an optical part contained in an antistatic container is used in photolithography, and as the irradiation light therefor is brought to a shorter wavelength in an ultraviolet region, that is, to KrF laser light, ArF laser light and further to F2 laser light, the problem of the minute particle soiling caused by crystallization has become pronounced due to increased actinic energy of the irradiation light.

However, as a result of our further study for various compositional improvements in the above-mentioned hydrophilic polymer-based permanent antistatic resin composition, we have found it possible to achieve an effect of preventing the above-mentioned problem of haze or discoloration of a shaped product surface, or in the case of a shaped container product, the surface haze or discoloration of the content material, by adding a compound of a polyvalent metal having a valence of at least 2, such as Ca or Al, in a relatively small amount of 0.001-0.5 wt. part per 100 wt. parts of the resin, thus arriving at the present invention.

Incidentally, the above-mention effect of addition of a polyvalent metal compound should be distinguished from that of (a) a surfactant, particularly a divalent metal salt (or an alkaline earth metal salt), possibly added in such an antistatic resin composition, for enhancing the antistatic property, or (b) a polyvalent metal salt added as a salting-out agent for recovering the hydrophilic polymer and caused to remain in the resultant antistatic resin composition. First, such a polyvalent metal salt present in the form of (a) or (b) in an antistatic resin composition as mentioned above is ordinarily in an amount exceeding 0.5 wt. part per 100 wt. parts of the resin. Second, in the above-mentioned case (a) of being added as an anionic surfactant, an alkaline earth metal salt is described in parallel with an alkali metal salt in many publications, it is usual that the former is described secondarily relative to the latter (or an equivalent to the latter in a sense), and it is seldom that the former is used preferentially to the latter. In contract thereto, the effect of improved transparence of a shaped product of an antistatic resin composition utilized in the present invention is an effect peculiar to a polyvalent metal compound not attainable by addition of a monovalent metal compound. (See Comparative Examples 1 and 3 containing only an alkali metal salt as an anionic surfactant). The clear mechanism thereof has not been clarified as yet, but it is presumed that a polyvalent metal having a valance of at least 2 has a function of forming a complex with an acidic gas or a basic gas when such a gaseous substance is adsorbed to obstruct the crystal growth of the gaseous substance on the shaped product surface.

As for (b) the polyvalent metal salt possibly used as a salting-out agent for recovering a graft copolymer, as a preferable hydrophilic polymer used in the present invention, comprising a rubbery trunk polymer having an alkylene oxide group, such a metal salt is reported to be liable to remain in the resin and obstruct the adsorption of an anionic surfactant later added as an antistatic agent to the resin composition, thus obstructing the development of permanent antistatic property (WO-A 00/27917, page 4, lines 19-23 and page 19, lines 19-22; EP-A 117956, page 3, lines 34-38, and page 10, lines 55-57).

However, as a result of our further study, it has been found that the addition of a polyvalent metal compound to a product resin composition in an amount smaller than the level of (b) a salting-out agent remaining in the resin, or (a) an alkaline (earth) metal salt added as an anionic surfactant for enhancing the antistatic property, provides the effect intended by the present invention of preventing the above-mentioned haze or discoloration of a shaped product surface, or in the case of a shaped container product, the surface haze or clouding of the content material therein.

### BEST MODE FOR PRACTICING THE INVENTION

As the hydrophilic polymer (a) as a base resin for providing the antistatic resin composition of the present invention, hydrophilic polymers disclosed as permanent antistatic resins in the above-mentioned reference, “Japan Society of Static Electricity”, vol.21, No.5, pp.212-219, particularly in Table 6 on page 216, may be used. Such hydrophilic polymers may be characterized as polymers which are solid and have a high ionic conductivity at room temperature. Specific examples thereof may include: polyether-type hydrophilic polymers, inclusive of polyethylene oxide, polyether-ester-amide, polyether-amide-imide, ethylene oxide-epihalohydrin copolymer, and a graft copolymer of a rubber trunk polymer having a polyalkylene oxide group; quaternary ammonium salt-type hydrophilic polymers, such as quaternary ammonium salt-containing (meth)acrylate copolymers, quaternary ammonium salt-containing maleimide copolymers, and quaternary ammonium salt-containing methacrylimide copolymers; sulfonic acid-type hydrophilic polymers, such as poly-sodium styrenesulfonate; betaine-type hydrophilic polymers, such as carbobetaine graft copolymers; and polymeric charge transfer combinant-type hydrophilic polymers. Among the above, polyether-type hydrophilic polymers having (poly)alkylene oxide groups including at least partially (poly)ethylene oxide groups, are preferred, and particularly a graft copolymer basically identical to the one developed by the present applicant (JP-B 54-2462, corr. to GB-A 2070446, the disclosure of which is incorporated herein by reference) and having the following composition is preferably used.

That is, a graft-copolymer (A) obtained by graft-polymerizing (iv) 5 to 95 wt. parts of at least one species of ethylenically unsaturated monomer onto a rubber trunk polymer in an amount of 5 to 95 wt. parts (giving a total of 100 wt. parts with the ethylenically unsaturated monomer), which rubber trunk polymer in turn is a copolymer of
(i) 50-95 wt. % of at least one monomer selected from conjugated dienes and acrylate esters,
(ii) 5-50 wt. % of at least one species of monomers each having an ethylenic unsaturation and 4 to 500 alkylene oxide groups, preferably including at least 4 ethylene oxide groups, and
(iii) 0-40 wt. % of at least one species of ethylenically unsaturated monomer copolymerizable with the conjugated diene or acrylate ester (i).

The antistatic resin composition of the present invention is obtained by adding, to (a) 3-10 wt. parts of a hydrophilic polymer as described above, (b) 0-97 wt. parts of a thermoplastic resin, and (c) a divalent or a higher-valent metal salt in an amount giving a content of 0.001-0.5 wt. part per 100 wt. parts of the total of (a) and (b) in the resultant resin composition.

The thermoplastic resin (b) used together with the hydrophilic polymer (a) may be basically any arbitrary thermoplastic resin, and examples thereof may include: polyethylene, polypropylene, polyvinyl chloride, polyvinylidene chloride, aromatic vinyl polymers, nitrile resins, (meth)acrylic resins comprising homopolymers or copolymers of (meth)acrylate esters, ABS (acrylonitrile-butadiene-styrene) resin, acrylonitrile-styrene resin, polycarbonate resin, polyamide resins, polyester resins, and fluorine-containing resins. It is preferred to use a resin having good compatibility with the hydrophilic polymer (a). However, a resin, such as ABS resin, containing an aromatic vinyl component, such as styrene, is not desirable for the purpose of the present invention, since such a resin is liable to evolve a gaseous component causing haze or discoloration. For this reason, an aliphatic resin substantially free from an aromatic polymer component is preferred, and further preferred examples of the thermoplastic resin (b) may included: (meth)acrylic resin and nitrile resins.

The thermoplastic resin (b) may be added as desired to the hydrophilic polymer (a) in view of the processability, strength, etc., of the resultant composition, depending on the usage of the antistatic resin composition of the present invention, and can be omitted in some cases. In the case where the hydrophilic polymer (a) and the thermoplastic resin (b) are used in mixture, it is preferred that the hydrophilic polymer (a) occupies at least 3 wt. parts, more preferably 5-60 wt. parts, per 100 wt. parts of the total of (a) and (b), so as to ensure a necessary level of antistatic property. Further, in the case of using the above-mentioned graft copolymer (A) as a hydrophilic polymer (a), it is preferred that the rubber trunk polymer (AR) of the copolymer (A) occupies 5-80 parts, particularly 10-60 wt. parts, per 100 wt. parts in total of the hydrophilic polymer (a) and the thermoplastic resin (b).

The polyvalent metal compound (c) is used for the purpose of preventing the haze or discoloration of a shaped product surface, or in the case of a shaped container product, the haze of the content material surface. For the purpose of the present invention, the polyvalent metal compound (c) is used in a proportion of 0.001-0.5 wt. part, preferably 0.001-0.3 wt. part, further preferably 0.001-0.1 wt. part, per 100 wt. parts of the total of the hydrophilic polymer (a) and the thermoplastic resin (b). Below 0.001 wt. part, the haze-prevention effect becomes scarce, and in excess of 0.5 wt. part, the bleeding-out of the metal compound (c) per se is liable to be problematic.

The polyvalent metal compound (c) may be added at any time of polymerization, blending, shaping, etc. In the case of addition at the time of blending or shaping, for example, a master batch containing the metal compound (c) at a concentration of, e.g., 10 wt. % may be added in an amount of 0.01-5 wt. parts per 100 wt. parts of the total resin.

Examples of the polyvalent metal compound (c) having a valance of at least 2, preferably 2-4, may include: metal salts inclusive of alkaline earth metal salts, such as magnesium chloride, calcium chloride, magnesium oleate and calcium stearate; and IIIA-group metal salts, such as aluminum chloride and aluminum stearate; and also metal oxides, such as titanium oxide, zinc oxide and tin oxide. The exact mechanism by which such a polyvalent metal compound prevents the occurrence of haze due to an acidic gas or a basic has not been clarified as yet, but as mentioned above, it is presumed the polyvalent metal forms a complex with adsorbed acidic gas or basic gas to obstruct the crystal growth of such a gaseous substance on a shaped product surface.

A surfactant (d) may be used so as to be adsorbed on the hydrophilic polymer (a) to enhance the permanent antistatic property of the resultant antistatic resin composition, but can be omitted. In order to provide a good heat resistance, it is preferred to use an anionic surfactant having a thermal weight loss initiation temperature according to JIS-K7120 (hereinafter sometimes denoted by “Tng”) of at least 250° C. The thermal weight loss initiation temperature has been recognized to have some degree of correlation with the structure of an anionic surfactant, and examples of the anionic surfactant having a thermal weight loss initiation temperature of at least 250° C. may include: alkylbenzenesulfonic acid salts, alkylnaphthalene-sulfonic acid salts, aliphatic acid salts, perfluoroalkylsulfonic acid salts, trifluoromethane-sulfonic acid salts, and perfluoroalkylcarboxylic acid salts.

An antistatic resin composition obtained by using an anionic surfactant having a thermal weight loss initiation temperature of below 250° C. is liable to cause haze or discoloration of the shaped body and a lowering in antistatic property due to a decrease of the anionic surfactant, presumably because of decomposition, scattering, etc., of the anionic surfactant during the shaping and processing in the case of severer shaping and processing conditions for complying with mass production, etc.

Incidentally, examples of such anionic surfactants having a thermal weight loss initiation temperature of below 250° C. include: alkylsulfuric acid ester salts, succinic acid ester sulfonic acid salts, phosphoric acid ester salts, polyoxyethylene alkyl ethersulfuric acid salts and polyoxyethylene alkyl phenol ethersulfuric acid salts.

The selection of metal species constituting an anionic surfactant also has a relation with the effect of the anionic surfactant as an antistatic agent, and for the purpose of the present invention, a salt of an alkaline metal having an atomic number of 19 (corresponding to potassium) is preferred because of a large ionic diameter thereof suitable for providing a necessary antistatic property at a relatively small amount of addition, and also in view of a shorter time for blending with the hydrophilic polymer (a) and the thermoplastic resin (b) and better physical properties of the shaped product, particularly resistance to whitening with warm water.

The surfactant (d) may preferably be used in a proportion of 0.1-5 wt. parts per 100 wt. parts in total of the hydrophilic polymer (a) and the thermoplastic resin (b). Below 0.1 wt. part, the antistatic property-improving effect is scarce, and in excess of 5 wt. parts, the blending-out to the surface of a shaped product becomes remarkable to provide undesirable properties of the shaped product.

The antistatic resin composition of the present invention can further contain additives, as desired, such as an ultraviolet absorber, a thermal stabilizer, an antioxidant, a lubricant, a filler and dyes or pigments, in addition to the above-mentioned components (a)-(d), and the addition of these can be effected at any time of polymerization, blending, shaping, etc.

The antistatic resin composition of the present invention can be dispersed in an organic solvent to form a dispersion liquid of an application type or a film-forming type. Preferred examples of the organic solvent may include: aromatic hydrocarbons, such as benzene, toluene and xylene; chlorine-containing compounds, such as dichloromethane and chloroform; ethers, such as dioxane and tetrahydrofuran; ketones, such as acetone and methyl ethyl ketone; esters such as ethyl acetate and butyl acetate; and nitrogen-containing compounds, such as dimethylformamide and N-methylpyrrolidone. Further, a mixture of two or more species of solvents can also be used.

The concentration of the dispersion liquid is not particularly restricted but may preferably be on the order of 5-60 wt. %, more preferably 5-30 wt.

The antistatic resin composition of the present invention can be formed into arbitrary shaped products, such as sheets, films, pipes, profile shapes, and two-color-parts, through ordinary molding processes, such as injection molding, extrusion, compression molding and vacuum forming.

Specific examples of application thereof may include: electronic products, optical products, home electrical appliances, office automation machines and parts, semiconductor manufacturing apparatus-related products, photolithography-related products, and products related with display devices, such as liquid crystal panels and plasma display panels. Specific examples of shaped products may include: cases for photomasks (including reticles) and pelicles as protective films for such photomasks, color filter cases, wafer carries, wafer cassettes, tote bottles, wafer boats, IC chip trays, IC chip carriers, IC conveyer tubes, IC cards, tapes, reel packings, various cases, storage trays, storage bottles, conveyer parts such as bearings and conveyer rollers, magnetic card readers; in the field of office automation machines: transfer rollers, transfer belts, developing rollers and transfer drums for recording machines, print circuit board cassettes, bushes, paper and bill conveyer parts, paper feed rails, font cartridges, ink ribbon canisters, guide pins, trays rollers, gears, sprockets, computer housings, modem housings, monitor housings, CD-ROM housings, printer housings, connectors, and computer slots; in the filed of communication appliances: portable telephone handset parts, pagers and various slide members; in the filed of automobiles: lining materials, under-hoods, housings for electronic and electrical devices, gasoline tank caps, fuel filters, fuel line connectors, fuel line clips, fuel tanks, instrument bezels, door handles, various parts; and in other fields: electric wire and wire cable coating materials, electric wire supports, electric wave absorbers, flooring, carpets, fly-screening sheets, pallets, shoe soles, tapes, brushes, and blower fans. Among these, the antistatic resin composition of the present invention is preferably used to provide shaped case products for electronic or optical parts to which attachment or soiling, such as haze, should be extremely avoided.

### EXAMPLES

Hereinbelow, the present invention will be described more specifically based on Examples. Incidentally, “part(s)” used in Examples means “part(s) by weight” and physical properties described were measured according to methods described representatively below.

(i) Thermal Weight Loss Initiation Temperature (Tng)

According to JIS-K7120, 8 mg of a sample dried in advance at 80° C. was heated at a temperature increasing rate of 10° C./min in a nitrogen atmosphere, and the measurement was performed by using a thermobalance (“TG50”, made by Mettler Instrumente A.G.).

(ii) Volume Intrinsic Resistivity

According to JIS K-6911, a sample was subjected to 3 days of conditioning at temperature: 23° C. and humidity: 23% RH, and subjected to measurement by an ultra-super insulation meter (“SM-10E”, made by To a Dempa Kogyo K.K.).

The antistatic property of a shaped property may be correlated with a volume intrinsic resistivity (ohm.cm) of a material. Herein, a volume intrinsic resistivity of at most 10¹² is judged to be an excellent antistatic property; above 10¹² and below 10¹³, inferior antistatic properties; and above 10¹³, no antistatic property.

(iii) Transparency

According to JIS K-7015, a sample was subjected to measurement by a haze meter (“TC-H3DP, made by Tokyo Denshoku K.K.).

(iv) IR analysis: A surface part of a shaped product was wiped with an aluminum foil, and the attached substance was subjected to FT-IR (Fourier transform infrared spectroscopy) analysis by using a spectrometer (“IR-500”, made by Nippon Bunko K.K.)

(V) Ultraviolet Laser Light Irradiation Test.

A 6-inch photomask case (roughly measuring 160 mm×80 mm×160 mmH, for storing 5 photomask sheets) was made of ca. 510 g of a sample antistatic resin, and one quartz glass sheet for photomask (roughly measuring: 152 L×152 W×6.4 t (mm)) was stored therein. The case was then left standing at 40° C. for 3 days. The quartz glass sheet was taken out of the case and irradiated with 1 mJ/cm²/pulse of ArF laser light (wavelength: 193 mm) at a total dose of 20 KJ/cm² under a flow of an air-like mixture (of pure N₂: 79% and pure O₂ 21%). Then, the surface of the irradiated quartz glass sheet was observed with eyes, and wiped out with an aluminum foil. The attached substance was then subjected to FT-IR analysis by using a spectrometer (“IR-500”, made by Nippon Bunko K.K.) similarly as in the above (iv).

<<Production of Antistatic Resin Compositions>>

<Hydrophilic Polymer>

(Hydrophilic Polymer 1 (a-1))

Into a pressure-resistant reaction vessel equipped with a stirrer, a thermometer and a pressure gauge,

(a) a rubber trunk polymer-forming composition:

| | |
|---|---|
| 1,3-Butadiene (i) | 23 part(s) |
| Butyl acrylate (i) | ″ |
| Methoxypolyethylene glycol | 12 part(s) |
| methacrylate (ii) | |
| (having averagely ca. 23 ethylene | |
| oxide groups) | |
| t-Butyl hydroperoxide | 0.03 part(s) |
| Formaldehyde sodium sulfoxylate | 0.015 part(s) |
| Iron (III) ethylenediamine- | 0.0015 part(s) |
| tetraacetate | |
| Sodium pyrophosphate | 0.2 part(s) |
| Potassium oleate | 2.0 part(s) |
| Deionized water | 200 part(s) |

was charged and stirred at 60° C. for 10 hours. Latex of a rubber trunk polymer having an average particle size of 80 nm was obtained at a yield of 99%.

(b) To the above latex of rubber trunk polymer (65 parts as solid matter), a mixture of ethylenically unsaturated monomer (iv):

| | |
|---|---|
| Methyl methacrylate | 35 part(s) |
| Normal-octyl mercaptan | 0.3 part(s) |
| t-Butyl hydroperoxide | 0.02 part(s) |
| Formaldehyde sodium sulfoxylate | 0.02 part(s) |
| Potassium oleate | 1.0 part(s) |
| Deionized water | 50 part(s) |

was added, and the mixture was aerated with nitrogen and subjected to graft copolymerization at 60° C. for 10 hours. The latex was taken out, and 200 parts of hydrochloric acid aqueous solution (concentration: 0.7 wt. %) was added to cause precipitation. After dewatering and washing, a wet powder state graft copolymer having a moisture content of 43 wt. % was obtained. The product was dried at a hot air temperature of 100° C. by an airborne instantaneous drier to obtain Hydrophilic polymer 1 (a-1) (graft copolymer) in white powder form at a yield of 97%.
   (Hydrophilic Polymer 2 (a-2))

A commercially available polyether-ester-amide having a refracting index of 1.51 (“PELLESTAT 6321”, made by San'yo Kasei Kogyo K.K.) was used.

(Hydrophilic Polymer 3 (a-3))

A commercially available quaternary ammonium salt group-containing (meth)acrylate copolymer (“RHEOLEX AS-170”, made by Daiichi Kogyo Seiyaku K.K.) was used.

### EXAMPLE 1

With 50 parts of Hydrophilic polymer 1 (a-1) (containing 32.5 parts of rubber trunk polymer), 50 parts of methacrylic resin having a refractive index of 1.49 (“SMIPEX B-MHG”, made by Sumitomo Kagaku K.K.), 1.0 part of potassium dodecylbenzenesulfonate (anionic surfactant) having a thermal weight loss initiation temperature (Tng) of 430° C. and 0.05 part of calcium chloride (utmost pure reagent grade, made by Wako Jun'yaku Kogyo K.K.) were blended by means of a Henschel mixer to form a powdery antistatic resin composition. Then, the powdery composition was formed into pellets through a parallel twin-screw extruder having a cylinder diameter of 20 mm (“LABOPLASTMILL”, made by Toyo Seiki K.K.).

The pellets were molded by an injection molding machine (“IS-80EPN”, made by Toshiba Kikai K.K.) equipped with a mold for forming a flat sheet (100 L×50 W×3 t (mm)) under the conditions of a cylinder temperature=220° C., a mold temperature=40° C., and a residence time in the cylinder of 40 sec. The thus-molded flat sheet was immersed in ultrapure water and subjected to 15 min. of washing under application of ultrasonic wave, followed by 30 min. of drying in an oven at 40° C. The thus-treated flat sheet was left to stand under air flow in a glove box for one week and then subjected to measurement of Volume intrinsic resistivity and Transparency and FT-IR analysis of surface-attached substance.

### EXAMPLE 2

An antistatic resin composition was prepared and evaluated in the same manner as in Example 1 except for using 0.05 part of calcium stearate (pure reagent grade, made by Kanto Kagaku K.K.) instead of the calcium chloride.

### EXAMPLE 3

An antistatic resin composition was prepared and evaluated in the same manner as in Example 1 except for using 0.05 part of calcium stearate (pure reagent grade, made by Kanto Kagaku K.K.) instead of the calcium chloride.

### COMPARATIVE EXAMPLE 1

An antistatic resin composition was prepared and evaluated in the same manner as in Example 1 except for omitting the calcium chloride.

The results of evaluation according to Examples 1-3 and Comparative Example 1 described above are inclusively shown in the following Table 1.

TABLE 1

| | Example | | | |
|---|---|---|---|---|
| | 1 | 2 | 3 | Comp. 1 |
| (After washing) | | | | |
| Volume intrinsic | 5 × 10¹¹ | 3 × 10¹¹ | 3 × 10¹¹ | 2 × 10¹¹ |
| resistivity(Ω · cm) | | | | |
| Whole light | 90 | 90 | 90 | 90 |
| transmittance(%) | | | | |
| Haze (%) | 3 | 3 | 3 | 3 |
| (After standing in | | | | |
| glove box) | | | | |
| Volume intrinsic | 5 × 10¹¹ | 3 × 10¹¹ | 3 × 10¹¹ | 2 × 10¹¹ |
| resistivity(Ω · cm) | | | | |
| Whole light | 90 | 90 | 90 | 80 |
| transmittance (%) | | | | |
| Haze (%) | 3 | 3 | 3 | 12 |
| Surface attachment | none | none | none | observed |
| FT-IR analysis | — | — | — | amide |
| | | | | compound** |

**Judged to be an amide compound in view of characteristic absorption at wave numbers of 1650 cm⁻¹ and 1540 cm⁻¹.

As shown in Table 1, the shaped product (flat sheet) prepared from the composition of Comparative Example 1 containing substantially no polyvalent metal salt caused an increase in haze (and a lowing in transmittance) presumably attributable to the surface-attached amide compound, whereas the shaped products prepared from the compositions of Examples 1-3 were all free from such lowering in optical properties but retained beautiful appearances.

### EXAMPLE 4

An antistatic resin composition formed by omitting the potassium dodecylbenzenesulfonate from the composition of Example 1 was pelletized in the same manner as in Example 1.

The resultant pellets were molded into a 6-inch photomask case by using an injection molding machine equipped with a mold for the case under the conditions of a cylinder temperature of 200° C., a mold temperature of 40° C. and a residence time in the cylinder of 40 sec. A portion of the resultant photomask case was cut out to provide a sample sheet (50 L×50 W×3.5 t (mm)), which was then subjected to washing with ultrapure water and drying for 30 min in an oven at 40° C. and then to measurement of volume intrinsic resistivity in the same manner as in Example 1.

Another 6-inch photomask case was molded in the above-described manners and then subjected to the above-mentioned ultraviolet laser light irradiation test. That is, after being stored in the photomask case at 40° C. for 3 days, a quartz glass sheet was taken out of the case and subjected to ultraviolet laser light irradiation at a total dose of 20 kJ/cm².

The thus-irradiated quartz glass sheet was then subjected to the observation of surface-attached substance (haze component) and FT-IR analysis of the attached substance.

A summery of the antistatic resin composition and the evaluation results are inclusively shown in Table 2 appearing hereinafter together with those of Examples and Comparative Examples described below.

### EXAMPLE 5

A photomask case was molded and evaluated in the same manner as in Example 4 except for using pellets of an antistatic resin composition (identical to the one of Example 1) obtained by adding 1.0 part of potassium dodecylbenzene-sulfonate (an anionic surfactant, Tng=430° C.) to the composition of Example 4.

### EXAMPLE 6

A photomask case was molded and evaluated in the same manner as in Example 4 except for using pellets of an antistatic resin composition obtained by using 1.0 part of potassium nonafluorobutane-sulfonate (an anionic surfactant, Tng=460° C.) instead of the potassium dodecyl-benzenesulfonate in the composition of Example 5.

### EXAMPLE 7

A photomask case was molded and evaluated in the same manner as in Example 4 except for using pellets of an antistatic resin composition obtained by using 0.05 part (the same) of calcium stearate (pure reagent grade, made by Wako Jun'yaku K.K.) instead of the calcium chloride in the composition of Example 5.

### EXAMPLE 8

A photomask case was molded and evaluated in the same manner as in Example 4 except for using pellets of an antistatic resin composition obtained by using 0.05 part (the same) of aluminum stearate (pure reagent grade, made by Wako Jun'yaku K.K.) instead of the calcium chloride in the composition of Example 5.

### EXAMPLE 9

An antistatic resin composition was prepared by blending 12 parts of pellets of Hydrophilic polymer 2 (polyether-ester-amide) with 88 parts of a transparent ABS resin having a refractive index of 1.51 (“TOYORAC 900”) made by Toray K.K.) and 0.05 part of calcium chloride (utmost pure reagent grade, made by Wako Jun'yaku K.K.) by means of a ribbon blender. By using pellets of the antistatic resin composition, a photomask case was molded and evaluated otherwise in the same manner as in Example 4.

### EXAMPLE 10

A photomask case was molded and evaluated in the same manner as in Example 4 except for using pellets of an antistatic resin composition obtained by replacing the transparent ABS resin with 88 parts (the same) of a transparent nitrile resin (“BALLEX 3000N”, made by Mitsui Kagaku K.K.) in the composition of Example 4.

### EXAMPLE 11

An antistatic resin composition was prepared by blending 10 parts of powder of Hydrophilic polymer 3 (quaternary ammonium salt group-containing (meth)acrylate copolymer) with 90 parts of a methacrylic resin having a refractive index of 1.49 (“SMIPEX B-MHG”) made by Sumitomo Kagaku K.K.) and 0.05 part of calcium chloride (utmost pure reagent grade, made by Wako Jun'yaku K.K.) by means of a ribbon blender. By using pellets of the antistatic resin composition, a photomask case was molded and evaluated otherwise in the same manner as in Example 4.

### COMPARATIVE EXAMPLE 2

A photomask case was molded and evaluated in the same manner as in Example 4 except for using pellets of an antistatic resin composition obtained by omitting the calcium chloride from the composition of Example 4.

### COMPARATIVE EXAMPLE 3

A photomask case was molded and evaluated in the same manner as in Example 4 except for using pellets of an antistatic resin composition obtained by omitting the calcium chloride from the composition of Example 5.

### COMPARATIVE EXAMPLE 4

A photomask case was molded and evaluated in the same manner as in Example 4 except for using pellets of an antistatic resin composition obtained by omitting the calcium chloride from the composition of Example 9.

### COMPARATIVE EXAMPLE 5

A photomask case was molded and evaluated in the same manner as in Example 4 except for using pellets of an antistatic resin composition obtained by omitting the calcium chloride from the composition of Example 10.

### COMPARATIVE EXAMPLE 6

A photomask case was molded and evaluated in the same manner as in Example 4 except for using pellets of an antistatic resin composition obtained by omitting the calcium chloride from the composition of Example 11.

The evaluation results of Examples 4-11 and Comparative Examples 2-6 are inclusively shown in the following Table 2.

TABLE 2

| | | | | | Evaluation results | | |
|---|---|---|---|---|---|---|---|
| | Antistatic resin composition** | | | | Volume intrinsic | Surface state | |
| | Hydrophilic | Thermoplastic | Polyvalent | | resistivity | after ArF | Haze |
| Example | resin | resin | metal salt | Surfactant | (Ω · cm) | irradiation | component |
| 4 | a-1 | b-1 | c-1 | — | 2 × 10¹² | no change | — |
| 5 | a-1 | b-1 | c-1 | d-1 | 3 × 10¹¹ | no change | — |
| 6 | a-1 | b-1 | c-1 | d-2 | 2 × 10¹¹ | no change | — |
| 7 | a-1 | b-1 | c-2 | d-1 | 3 × 10¹¹ | no change | — |
| 8 | a-1 | b-1 | c-3 | d-1 | 3 × 10¹¹ | no change | — |
| 9 | a-2 | b-2 | c-1 | — | 1 × 10¹² | no change | — |
| 10 | a-2 | b-3 | c-1 | — | 1 × 10¹² | no change | — |
| 11 | a-3 | b-1 | c-1 | — | 1 × 10¹² | no change | — |
| Comp. 2 | a-1 | b-1 | — | — | 1 × 10¹² | haze | ammonium sulfate |
| Comp. 3 | a-1 | b-1 | — | d-1 | 2 × 10¹¹ | haze | ammonium sulfate |
| Comp. 4 | a-2 | b-2 | — | — | 1 × 10¹² | haze | ammonium sulfate |
| Comp. 5 | a-2 | b-3 | — | — | 1 × 10¹² | haze | ammonium sulfate |
| Comp. 6 | a-3 | b-1 | — | — | 1 × 10¹² | haze | ammonium sulfate |

**a-1 to a-3: Hydrophilic polymers 1 to 3, respectively, b-1: methacrylic resin, b-2: transparent ABS resin, b-3: nitrile resin, c-1: calcium chloride, c-2: calcium stearate, c-3: aluminum stearate, d-1: potassium dodecylbenzenesulfonate, d-2: potassium nonafluorobutanesulfonate.

As is understood from the above Table 2, the antistatic resin compositions (of Examples 4-11) according to the present invention all exhibited antistatic property (i.e., a low volume intrinsic resistivity) and provided a shaped container product free from causing a haze comprising ammonium sulfate on a quartz glass sheet which was irradiated with ArF laser light after the storage in the shaped container product.

On the other hand, the antistatic resin compositions containing no polyvalent metal salt (of Comparative Examples 2-7) all exhibited antistatic property (a low volume intrinsic resistivity) but provided a shaped container causing a haze comprising ammonium sulfate on a quartz glass sheet after storage therein and irradiation with ArF laser light.

### INDUSTRIAL APPLICABILITY

As described above, according to the present invention, there is provided an antistatic resin composition which is commercially efficiently producible by admixing a small amount of polyvalent metal salt with a thermoplastic resin comprising a hydrophilic polymer and capable of providing a shaped product having a stably beautiful appearance free from haze or discoloration due to an acidic or a basic gas in the air and retaining permanent antistatic property. Further, the antistatic resin composition also provides a shaped container product which is little liable to occurrence of a crystalline substance causing a haze or discoloration of an optical part, etc., even when the optical part, etc. is irradiated with ultraviolet laser light after being stored in the shaped container product.

1. An antistatic resin composition, comprising:
(a) a hydrophilic polymer: 3-100 wt. parts,
(b) a thermoplastic resin: 0-97 wt. parts (giving a total of 100 wt. parts together with the hydrophilic polymer (a)), and
(c) a polyvalent metal compound: 0.001-0.5 wt. part, said polyvalent metal compound being a polyvalent metal salt selected from the group consisting of magnesium chloride, calcium chloride, magnesium oleate, calcium stearate aluminum chloride and aluminum stearate.

2. An antistatic resin composition according to claim 1, wherein the polyvalent metal compound (c) is a polyvalent metal salt selected from the group consisting of calcium chloride, calcium stearate and aluminum stearate.

3. An antistatic resin composition according to claim 1, wherein the hydrophilic polymer (a) is a polyalkylene oxide group-containing polymer.

4. An antistatic resin composition according to claim 3, wherein the hydrophilic polymer (a) is a graft copolymer obtained by graft polymerizing an ethylenically unsaturated monomer onto a rubber trunk polymer having alkylene oxide groups.

5. An antistatic resin composition according to claim 3, wherein the hydrophilic polymer (a) is a graft-copolymer obtained by graft-polymerizing (iv) 5 to 95 wt. parts of at least one species of ethylenically unsaturated monomer onto a rubber trunk polymer in an amount of 5 to 95 wt. parts (giving a total of 100 wt. parts with the ethylenically unsaturated monomer), which rubber trunk polymer in turn is a copolymer of
(i) 50-95 wt. % of at least one monomer selected from conjugated dienes and acrylate esters,
(ii) 5-50 wt. % of at least one species of monomers each having 4 to 500 alkylene oxide groups and an ethylenic unsaturation, and
(iii) 0-40 wt. % of at least one species of ethylenically unsaturated monomer copolymerizable with the conjugated diene or acrylate ester (i).

6. An antistatic resin composition according to claim 1, further containing a surfactant (d).

7. An antistatic resin composition according to claim 6, wherein the surfactant (d) is at least one species of anionic surfactant selected from the group consisting of alkylbenzenesulfonic acid salts, alkylnaphthaenesulfonic acid salts, perfluoroalkylsulfonic acid salts, trifluoromethanesulfonic acid salts, perfluoroalkylcarboxylic acid salts and aliphatic acid salts.

8. An antistatic resin composition according to claim 6, wherein the surfactant (d) is an anionic surfactant comprising a salt of an alkaline metal having an atomic number of 19 (corresponding to potassium) or larger.

9. An antistatic resin composition according to claim 1, wherein the thermoplastic resin (b) is an aliphatic resin.

10. A dispersion liquid obtained by dispersing an antistatic resin composition according to claim 1 in an organic solvent.

11. A shaped product obtained by shaping an antistatic resin composition according to claim 1.

12. A shaped product according to claim 11, which is resistant to thermal decomposition.

13. A shaped product according to claim 11, which is resistant to decomposition by irradiation with ultraviolet light.

14. A shaped product according to claim 11, which has a form of container for storing an electronic part or an optical part therein.

15. A shaped product according to claim 14, which has a form of container for storing an optical part comprising a photomask or a protective film for a photomask to be illuminative with laser light.

16. Use of an antistatic resin composition for forming therefrom a container for storing a photomask or a protective film for a photomask to be illuminated with laser light, said antistatic resin composition comprising:
(a) a hydrophilic polymer: 3-100 wt. parts,
(b) a thermoplastic resin: 0-97 wt. parts (giving a total of 100 wt. parts together with the hydrophilic polymer (a)), and
(c) a polyvalent metal compound: 0.001-0.5 wt. part.
